(19) United States
(12) Patent Application Publication
(10) Pub. No.: US 2026/0149481 A1
(43) Pub. Date: May 28, 2026

(54) METHOD FOR DETECTING TARGET, SIGNAL PROCESSING METHOD AND INTEGRATED CIRCUIT

(71) Applicant: Calterah Semiconductor Technology (Shanghai) Co., Ltd., Shanghai (CN)

(72) Inventors: Tongyu ZHU, Shanghai (CN); Yi CHEN, Shanghai (CN); Xiao WANG, Shanghai (CN); Lei ZHANG, Shanghai (CN); Luning TANG, Shanghai (CN)

(21) Appl. No.: 19/455,776

(22) Filed: Jan. 21, 2026

Related U.S. Application Data
(63) Continuation of application No. PCT/CN2024/133998, filed on Nov. 22, 2024.

(30) Foreign Application Priority Data
Nov. 1, 2023 (CN) 202311449163.3

(51) Int. Cl. H04B 1/713; H04B 1/00

(52) U.S. Cl. CPC H04B 1/713; H04B 1/0053

(57) ABSTRACT

The disclosed is a target detection method, including: dividing a Doppler spectrum into N sub-bands, extracting energies of N signals from the Doppler spectrum; among the N signals, traversing position orders of signals corresponding to multiple transmission antennas; based on a respective total energy of the signals corresponding to the multiple transmission antennas under each position order, determining sub-bands to which the signals corresponding to the multiple transmission antenna belong. By traversing position orders of the signals of the multiple transmission antennas, a position order corresponding to a maximum total energy can be used to determine positions of the signals of the multiple transmission antennas in the sub-bands, ensuring the accuracy of the channel separation of each transmission antenna and thereby increasing target detection accuracy. Further disclosed are a signal processing method, a computer-readable storage medium, an integrated circuit, a radio device, and a terminal device.

### CROSS REFERENCE TO RELATED APPLICATIONS

The present application is a continuation of PCT Patent Application No. PCT/CN2024/133998, entitled “TARGET DETECTION METHOD, SIGNAL PROCESSING METHOD AND INTEGRATED CIRCUIT,” filed Nov. 12, 2024, which claims priority to Chinese patent application No. CN202311449163.3, entitled “METHOD FOR DETECTING TARGET, SIGNAL PROCESSING METHOD AND INTEGRATED CIRCUIT,” filed Nov. 1, 2023, each of which is incorporated by reference herein in its entirety.

### TECHNICAL FIELD

The various embodiments of the present disclosure relate to the technical field of radio communication, and in particular to a method for detecting a target, a signal processing method, and an integrated circuit.

### BACKGROUND

Generally, a frequency modulated continuous wave (FMCW) radar first transmits a detection signal of a waveform of linearly sweep frequency pulse and receives an echo signal formed by a detection signal scattered and/or reflected by a target. The echo signal is then mixed with a local oscillator (LO) signal output by a local oscillator to obtain an intermediate frequency signal. After analog-to-digital conversion and sampling of the intermediate frequency signal, coherent processing is performed on the processed intermediate frequency signal to detect the target and measure target parameters such as range, speed, and angle.

Currently, millimeter-wave radar transmission modes include multiple input multiple output (MIMO) based on time division multiplexing (TDM) and MIMO based on doppler division multiplexing (DDM). In a DDM mode, a plurality of transmission antennas may transmit signals simultaneously, which can achieve higher transmission gain compared to TDM. However, how to accurately separate transmission channels in a DDM mode is a problem to be solved.

### SUMMARY

Embodiments of the present disclosure provide a method for detecting a target, a signal processing method, and an integrated circuit, which achieve accurate separation of the transmission channel in a DDM mode, thereby improving an accuracy of target detection.

To address the aforementioned technical problems, some embodiments of the present disclosure provide a method for detecting a target. The method includes: transmitting detection signals using a plurality of transmission antennas; receiving an echo signal related to one or more of the detection signals; performing range-dimensional FFT and Doppler-dimensional FFT on echo signals to obtain a Doppler spectrum in a preset range bin; and extracting energies of N signals from the Doppler spectrum. The Doppler spectrum includes N sub-bands, and each of the N signals belong to a respective sub-band of the N sub-bands. The method includes: calculating a respective total energy of signals corresponding to a plurality of transmission antennas in each positional order of positional orders, and determining the signals corresponding to the plurality of transmission antennas from the N signals according to a positional order corresponding to a maximum total energy among the positional orders; and obtaining parameters of the target based on signal energies in signal sub-bands to which the signals corresponding to the plurality of transmission antennas belong.

Some embodiments of the present disclosure also provide a method for detecting a target. The method includes: performing range-dimensional FFT and Doppler-dimensional FFT on an echo signal to obtain a Doppler spectrum in a preset range bin, and dividing the Doppler spectrum into N sub-bands to determine signal sub-bands to which signals corresponding to transmission antennas belong. The method includes: determining a target to be confirmed based on signal energies in the signal sub-bands; and determining a first confidence of the target to be confirmed. The first confidence is configured for representing a difference between a first total energy of the target to be confirmed and a second total energy of the target to be confirmed. The first total energy refers to a total energy of signal energies of the target to be confirmed in the signal sub-bands, and the second total energy refers to a sum of the first total energy and a total energy of signal energies of the target to be confirmed in at least one leakage sub-band. The at least one leakage sub-band refers to remaining sub-bands of the N sub-bands in addition to the signal sub-bands. The method further includes: determining whether the target to be confirmed is a false target based on the first confidence; and in response to determining that the target to be confirmed is not the false target, obtaining parameters of the target to be confirmed.

Some embodiments of the present disclosure also provide a method for detecting a target. The method includes: performing range-dimensional FFT and Doppler-dimensional FFT on an echo signal to obtain a Doppler spectrum in a preset range bin, and dividing the Doppler spectrum into N sub-bands to determine signal sub-bands to which signals corresponding to transmission antennas belong. The method includes: determining a target to be confirmed based on signal energies in the signal sub-bands; and determining a second confidence of the target to be confirmed. The second confidence is configured for representing a difference between a first energy value and a second energy value of the target to be confirmed. The first energy value refers to a minimum energy value of the target to be confirmed in the signal sub-bands, and the second energy value refers to a maximum energy value of the target to be confirmed in leakage sub-bands. The leakage sub-bands are remaining sub-bands of the N sub-bands in addition to the signal sub-bands. The method further includes: determining whether the target to be confirmed is a false target based on the second confidence; and in response to determining that the target to be confirmed is not the false target, obtaining parameters of the target to be confirmed.

Some embodiments of the present disclosure also provide a signal processing method, including: performing spectral analysis on an echo signal to obtain a two-dimensional range-Doppler spectrum; dividing a target data spectrum in the two-dimensional range-Doppler spectrum into N sub-bands in a Doppler dimension based on a minimum step phase of signals transmitted by transmission antennas; and determining signal sub-bands of the N sub-bands and/or determining an order of the signal sub-bands corresponding to the signals transmitted by the transmission antennas based on a phase stepping law of the signals transmitted by transmission antennas and total energies of combinations of the signal sub-bands. The signal sub-bands refer to sub-bands having target peak signals.

Some embodiments of the present disclosure also provide a non-transitory computer-readable storage medium, configured for storing a computer program, which, when executed by a processor, causes the processor to perform operations of the method for detecting the target above.

Some embodiments of the present disclosure also provide an integrated circuit, including: at least one processor; and a memory communicatively connected to the at least one processor. The memory is configured for storing instructions executable by the at least one processor, which, when executed by the at least one processor, cause the at least one processor to perform the methods described above.

Some embodiments of the present disclosure also provide a wireless device, including: a carrier; an integrated circuit as described above, disposed on the carrier; antennas disposed on the carrier, or the antennas and the integrated circuit are integrated and disposed on the carrier. The integrated circuit is connected to the antennas and is configured for transmitting target detection signals and/or receiving echo signals.

Some embodiments of the present disclosure also provide a terminal device, including: a device body; and the radio device as described above disposed on the device body. The radio device is configured for target detection to provide reference information for operations of the device body.

In the embodiments, the Doppler spectrum includes N sub-bands, the energies of N signals are extracted from the Doppler spectrum, and the positional orders of the signals corresponding to the plurality of transmission antennas are traversed in the N signals. Based on the respective total energy of the signals corresponding to the plurality of transmission antennas in each positional order of the positional orders, the sub-bands to which the signals corresponding to the transmission antennas belong are determined. Since positions of the signals corresponding to the plurality of transmission antennas in the sub-bands is determined by traversing the positional orders of the signals corresponding to the plurality of transmission antennas and using the positional order corresponding to the maximum total energy among the positional orders, an accuracy of channel separation of the plurality of transmission antennas is guaranteed, thereby improving an accuracy of target detection.

### BRIEF DESCRIPTION OF THE DRAWINGS

One or more embodiments are illustrated by way of example with reference to the accompanying drawings, and these illustrative descriptions do not constitute a limitation on the embodiments.

FIG. 1 is a flowchart of a method for detecting a target according to some embodiments of the present disclosure;

FIG. 2 is a schematic diagram of a DDM-MIMO waveform with non-uniform spacing according to some embodiments of the present disclosure;

FIG. 3 is a schematic diagram of a Doppler spectrum in a preset range bin according to some embodiments of the present disclosure;

FIG. 4 is a flowchart of obtaining parameters of the target based on signal energies in signal sub-bands according to some embodiments of the present disclosure;

FIG. 5 is another flowchart of obtaining parameters of the target based on signal energies in signal sub-bands according to some embodiments of the present disclosure;

FIG. 6 is a schematic diagram of a second confidence according to some embodiments of the present disclosure;

FIG. 7 is a second flowchart of a method for detecting a target according to some embodiments of the present disclosure;

FIG. 8 is a third flowchart of a method for detecting a target according to some embodiments of the present disclosure;

FIG. 9 is a flowchart of a signal processing method according to some embodiments of the present disclosure;

FIG. 10 is a schematic structural diagram of an integrated circuit according to some embodiments of the present disclosure.

### DETAILED DESCRIPTION OF THE EMBODIMENTS

Currently, there are two main methods for separating transmission channels in DDM mode. One is using uniform Doppler interval DDM-MIMO waveforms. This method is not affected by leakage and does not have a problem of false alarm points caused by leakage. However, when a radial velocity of a target exceeds a maximum unambiguous velocity allocated to a transmission antenna, a peak of a spectrum will appear in a portion of a spectrum corresponding to the other transmission antenna, thereby resulting in incorrect channel separation.

Another method is using non-uniformly spaced DDM-MIMO waveforms. Different transmission antennas have a fixed relative positional relationship in Doppler dimension. If the radial velocity of the target is large, spectrums of different transmission antennas will overlap. Combined with a channel separation algorithm, channel separation can be achieved using non-uniform DDM waveforms.

The present disclosure proposes a method for detecting a target. The method is applicable to non-uniformly spaced DDMs. Positions of signals corresponding to a plurality of transmission antennas in sub-bands is determined by traversing positional orders of the signals corresponding to the plurality of transmission antennas and using a positional order corresponding to a maximum total energy among the positional orders, an accuracy of channel separation of the plurality of transmission antennas is guaranteed, thereby improving an accuracy of target detection. Furthermore, by using a confidence of a target to be confirmed, a determination can be made regarding false targets, further enhancing the accuracy of target detection.

To make the objectives, technical solutions, and advantages of the embodiments of the present disclosure clearer, the various embodiments of the present disclosure will be described in detail below with reference to the accompanying drawings. However, those skilled in the art will understand that many technical details have been provided in the various some embodiments of the present disclosure to help readers better understand the present disclosure. However, the technical solutions claimed in the present disclosure can be implemented even without these technical details and various changes and modifications based on the following embodiments. The division of the various embodiments below is for the convenience of description and should not constitute any limitation on the specific implementation of the present disclosure. The various embodiments can be combined with and referenced by each other without contradiction.

Those skilled in the art will understand that electromagnetic wave signals include radio waves and light waves. The radio waves further include shortwaves, medium waves, long waves, and microwaves, while light waves include ultraviolet, visible light, and infrared. Microwaves further include centimeter waves and millimeter waves. The centimeter waves mainly include Ultra Wide Band (UWB) with 3.1 GHz˜10.6 GHz band and 24 GHz band, while millimeter waves mainly include a 60 GHz band and a 77 GHz band (or a 77 GHz band to 81 GHz band). Ultraviolet and visible light can be collectively referred to as lasers, including visible and invisible lasers. The frequency range of lasers is mainly (3.846˜7.895)*10⁵ Hz. Some embodiments of the present disclosure mainly involve signal processing for centimeter waves, millimeter waves, and laser frequency bands.

Some embodiments of the present disclosure relate to a method for detecting a target. The method is applicable to a radar chip, or to other components, such as terminal devices, and integrated circuits that require acquiring parameters of the target. Implementation details of embodiments of the present disclosure are described below for ease of understanding and are not essential for implementing solutions.

In some embodiments, the method includes: performing range-dimensional FFT and Doppler-dimensional FFT on an echo signal to obtain a Doppler spectrum in a preset range bin; and extracting energies of N signals from the Doppler spectrum. The Doppler spectrum includes N sub-bands, and each of the N signals belongs to a respective sub-band of the N sub-bands. The method includes: calculating a respective total energy of signals corresponding to a plurality of transmission antennas in each positional order of positional orders, and determining the signals corresponding to the plurality of transmission antennas from the N signals according to a positional order corresponding to a maximum total energy among the positional orders; and obtaining parameters of the target based on the signal energy in the signal sub-bands. The signal sub-bands are sub-bands to which the signals corresponding to the plurality of transmission antennas belong. For ease of understanding, the following embodiments mainly use the example of obtaining N sub-bands by uniformly dividing the Doppler spectrum.

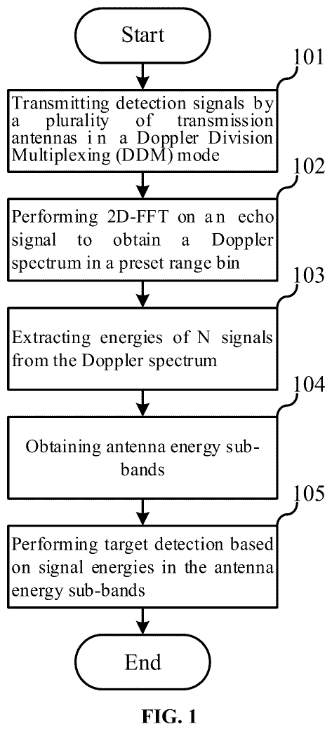

As shown in FIG. 1, in operation 101, transmitting detection signals by a plurality of transmission antennas in a Doppler Division Multiplexing (DDM) mode.

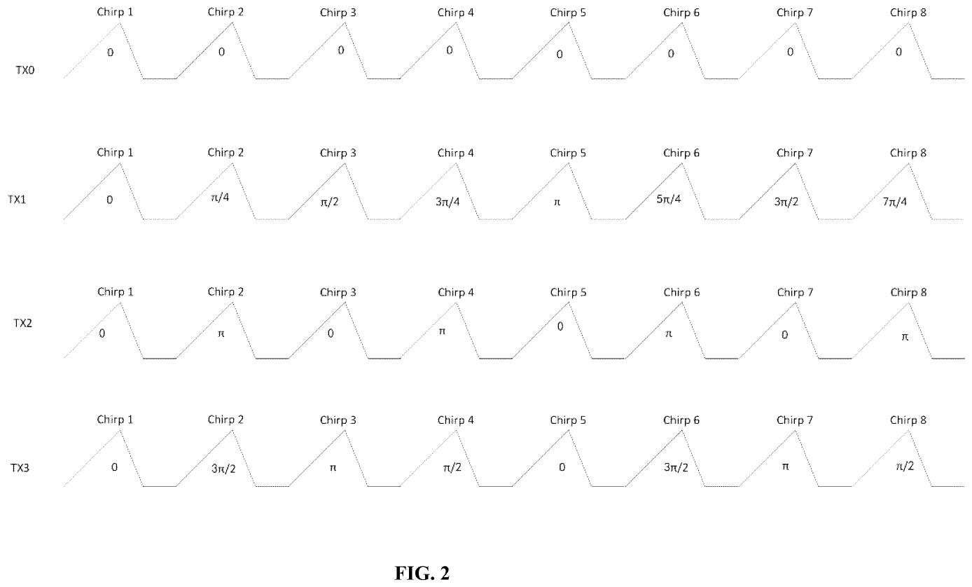

In some examples, taking a radar system having four transmission antennas (4TX) and four receiving antennas (4RX) as an example, the radar system transmits detection signals simultaneously by the four transmission antennas using a non-uniformly spaced DDM-MIMO waveform, as shown in FIG. 2. TX0 has a phase-shift step of 0°, TX1 a phase-shift step of 45° (π/4), TX2 a phase-shift step of 180° (π), and TX3 a phase-shift step of 270° (3π/2). An echo signal received by each of the four receiving antennas includes a signal corresponding to a respective transmission antenna of the four transmission antennas. Since the phase-shift steps of the four transmission antennas are fixed, a relative position of a signal in the echo signal corresponding to the respective transmission antennas is also fixed.

In operation 102, performing range-dimensional fast Fourier transform (FFT) and Doppler-dimensional FFT (i.e., 2D-FFT) on an echo signal to obtain a Doppler spectrum in a preset range bin. Specifically, the echo signals received by the receiving antennas needs to be mixed with a local oscillator output signal to obtain intermediate frequency signals. Then, the intermediate frequency signals are subjected to analog-to-digital conversion to obtain digital signals, and the digital signals are subjected to range-dimensional FFT and Doppler-dimensional FFT to obtain the Doppler spectrum in the preset range bin. The Doppler spectrum in the preset range bin may be data directly output after performing 2D-FFT, or data output in response to Constant False Alarm Rate (CFAR) Detector. It should be noted that this example only uses the range-dimensional FFT and the Doppler-dimensional FFT to implement the 2D-FFT in operation 102. In application, any other method that can obtain the Doppler spectrum in the preset range bin can also be used to implement the 2D-FFT. The relevant technologies have been recorded and will not be repeated here.

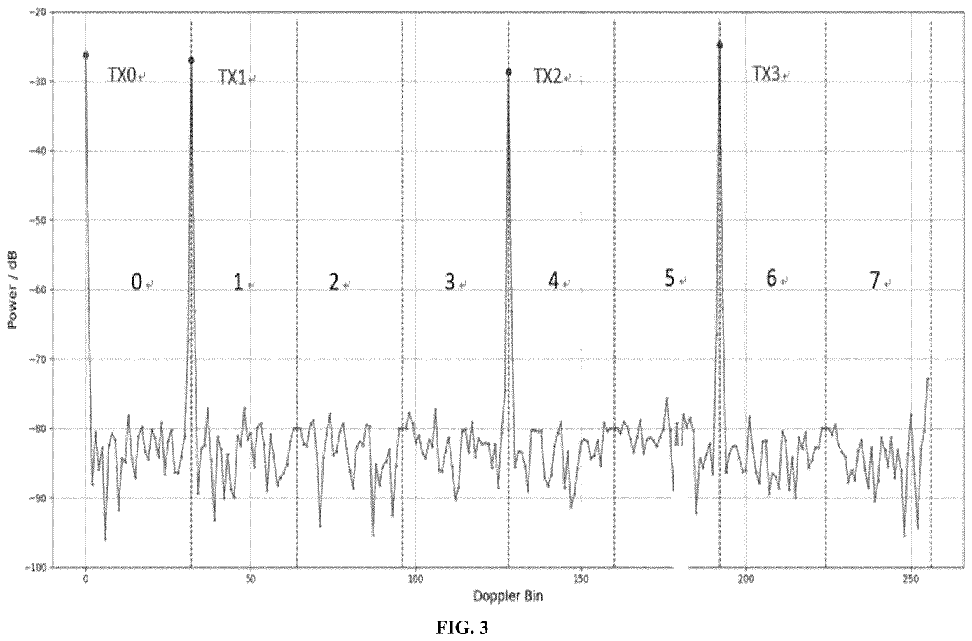

In some examples, a result of the 2D-FFT for a stationary target is shown in FIG. 3. FIG. 3 illustrates a Doppler spectrum in a preset range bin, including N sub-bands at equal intervals. N is determined based on a minimum phase-shift step of the plurality of transmission antennas relative to a reference transmission antenna. Taking the aforementioned radar system having 4TXs and 4RXs as an example, TX0 is the reference transmission antenna, TX1 has a phase-shift step of 45° relative to TX0, TX2 has a phase-shift step of 180° relative to TX0, and TX3 has a phase-shift step of 270° relative to TX0. That is, the plurality of transmission antennas have a minimum phase-shift step of 45° relative to the reference transmission antenna. Since 360° includes eight 45°-intervals, N is 8 (in this case, the Doppler spectrum includes eight sub-bands at equal intervals, namely sub-band 0, sub-band 1, sub-band 2, sub-band 3, sub-band 4, sub-band 5, sub-band 6, and sub-band 7 in FIG. 3, defined by every two dashed lines). In some examples, in response to the plurality of transmission antennas having a minimum phase-shift step of 60° relative to the reference transmission antenna, N is 6, i.e., N is a positive integer. In some examples, in response to signals transmitted by the plurality of transmission antennas having a minimum phase-shift step of 30°, the Doppler spectrum includes 12 sub-bands, (i.e., N is 12), due to 360° including twelve 60°-intervals. Of course, the above are only examples illustrating the minimum phase shift and its corresponding Doppler spectrum division under different conditions. In some embodiments, the minimum phase shift and its corresponding Doppler spectrum division can be specifically set according to actual needs and differ from the above examples, which will not be repeated here. It is worth mentioning that the radar system in the embodiments may have multiple transmitters and multiple receivers or have multiple transmitters and a single receiver, which will be not limited here, as long as a number of the transmission antennas is less than a number of the sub-bands N. For ease of understanding, the following explanation mainly uses a minimum phase shift of 45° and N=8 as an example.

In operation 103, extracting energies of N signals from the Doppler spectrum, where each of the N signals belongs to a respective sub-band of the N sub-bands. That is, one respective signal of the N signals is extracted from each sub-band of the N sub-bands, and every two adjacent signals of the N signals are spaced by a same number of Doppler bins. In some examples, the extracted N signals include at least one peak. It should be noted that, in some embodiments of the present disclosure, when obtaining the Doppler spectrum in the preset range bin, subsequent operations are performed on the Doppler spectrum in the preset range bin, rather than Doppler spectrums in different range bins, which will not be repeated here and thereafter.

Specifically, taking an N of 8 and a Doppler spectrum including 256 Doppler bins as an example, when dividing the Doppler spectrum into N sub-bands at equal intervals, each of the N sub-bands includes 32 Doppler bins. A signal is extracted from each of the 8 sub-bands, and every two adjacent signals are spaced by a same number of Doppler bins. For example, when a Doppler bin value of a signal extracted from a first sub-band is 1, then a Doppler bin value of a signal extracted from a second sub-band is 1+32, a Doppler bin value of a signal extracted from a third sub-band is 1+32×2, and so on, thereby ensuring that every two adjacent signals of the N signals are spaced by a same number of Doppler bins.

In operation 104, obtaining antenna energy sub-bands, that is, obtaining signal sub-bands to which signals corresponding to the plurality of transmission antennas belong. In this operation, positional orders of the signals corresponding to the plurality of transmission antennas in the N signals are traversed, a respective total energy of the signals corresponding to the plurality of transmission antennas in each positional order of the positional orders is calculated, and the signals corresponding to the plurality of transmission antennas are determined from the N signals according to a positional order corresponding to a maximum total energy among the positional orders, thereby determining the signal sub-bands.

In radar operation, a detected target speed may be in any of the Doppler bins, meaning a position of TX0 may be in any of the N sub-bands. Taking N=8 in the example above, the position of TX0 (i.e., a position of a signal corresponding to TX0 in the Doppler spectrum) may have 8 probabilities. Since the relative position of the signal in the echo signal corresponding to each of the plurality of transmission antennas is fixed, positions of TX1, TX2, and TX3 are also fixed when the position of TX0 is fixed. As shown in FIG. 3, when the signal corresponding to TX0 is in a 0-th Doppler bin in the Doppler spectrum, the signal corresponding to TX1 is in a 32-nd Doppler bin, the signal corresponding to TX2 is in a 128-th Doppler bin, and the signal corresponding to TX3 is in a 192-nd Doppler bin.

Therefore, given that it is uncertain which sub-band the signal corresponding to TX0 is located in, all positional orders of the TXs are shown in Table 1.

TABLE 1
Different combinations of the TX orders

| | Sub-band | | | | | | | | |
|---|---|---|---|---|---|---|---|---|---|
| Probability | 0 | 1 | 2 | 3 | 4 | 5 | 6 | 7 | TX order |
| Probability 1 | TX0 | TX1 | | | TX2 | | TX3 | | 0 1 4 6 |
| Probability 2 | | TX0 | TX1 | | | TX2 | | TX3 | 1 2 5 7 |
| Probability 3 | TX3 | | TX0 | TX1 | | | TX2 | | 2 3 6 0 |
| Probability 4 | | TX3 | | TX0 | TX1 | | | TX2 | 3 4 7 1 |
| Probability 5 | TX2 | | TX3 | | TX0 | TX1 | | | 4 5 0 2 |
| Probability 6 | | TX2 | | TX3 | | TX0 | TX1 | | 5 6 1 3 |
| Probability 7 | | | TX2 | | TX3 | | TX0 | TX1 | 6 7 2 4 |
| Probability 8 | TX1 | | | TX2 | | TX3 | | TX0 | 7 0 3 5 |

In Table 1, the TX order indicates a sub-band to which the signals corresponding to the four transmission antennas belong. For example, in Probability 1, the signal corresponding to TX0 is in the first sub-band (sub-band 0), the signal corresponding to TX1 is in the second sub-band (sub-band 1), the signal corresponding to TX3 is in the fifth sub-band (sub-band 4), and the signal corresponding to TX5 is in the seventh sub-band (sub-band 6).

By using cyclic displacement, the positional orders (as shown in Table 1) of the signals corresponding to the plurality of transmission antennas in the N sub-bands may be traversed, and a respective total energy of the signals corresponding to the plurality of transmission antennas in each positional order of the positional orders is calculated, thus obtaining total energies for N TX orders. Taking Table 1 as an example, the total energies for the 8 TX orders are:

$${A}_{0} = {S}_{0} + {S}_{1} + {S}_{4} + {S}_{6} ;$$

$${A}_{1} = {S}_{1} + {S}_{2} + {S}_{5} + {S}_{7} ;$$

$${A}_{2} = {S}_{2} + {S}_{3} + {S}_{6} + {S}_{0} ;$$

$${A}_{3} = {S}_{3} + {S}_{4} + {S}_{7} + {S}_{1} ;$$

$${A}_{4} = {S}_{4} + {S}_{5} + {S}_{0} + {S}_{2} ;$$

$${A}_{5} = {S}_{5} + {S}_{6} + {S}_{1} + {S}_{3} ;$$

$${A}_{6} = {S}_{6} + {S}_{7} + {S}_{2} + {S}_{4} ;$$

$${A}_{7} = {S}_{7} + {S}_{0} + {S}_{3} + {S}_{5} ;$$

Here, S₀ represents an energy value of a signal of the extracted 8 signals located in the first sub-band (sub-band 0), S₁ represents an energy value of a signal of the extracted 8 signals located in a second sub-band (sub-band 1), S₂ represents an energy value of a signal of the extracted 8 signals located in the third sub-band (sub-band 2), and so on.

Finding a maximum value in [A₀, A₁, A₂, A₃, A₄, A₅, A₆, A₇]. For example, when A₅ is the maximum value, an order of sub-bands of the signals corresponding to the signals transmitted by TX0-TX3 is [5, 6, 1, 3]. That is, the sub-band corresponding to the transmitted signal of TX0 is sub-band 5, the sub-band corresponding to the transmitted signal of TX1 is sub-band 6, the sub-band corresponding to the transmitted signal of TX2 is sub-band 1, and the sub-band corresponding to the transmitted signal of TX3 is sub-band 3.

In other words, the signals corresponding to the plurality of transmission antennas are determining from the N signals according to a positional order corresponding to a maximum total energy among the positional orders, to determine the signal sub-bands, that is, the sub-bands to which the signals corresponding to the plurality of transmission antennas belong.

In operation 105, performing target detection based on signal energies in the antenna energy sub-bands. That is, obtaining parameters of the target, such as speed, range, and angle of the target, based on the signal energies in signal sub-bands.

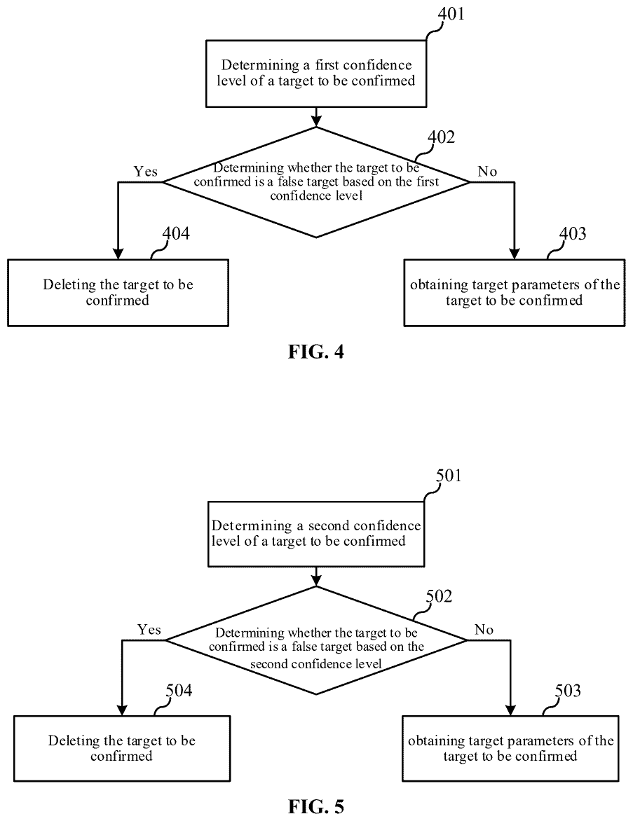

In some examples, a specific process for obtaining the parameters of the target based on the signal energies in the signal sub-bands is shown in FIG. 4. In operation 401, determining a first confidence (tx_order_conf1) of a target to be confirmed. The first confidence is configured for representing a difference between a first total energy of the target to be confirmed and a second total energy of the target to be confirmed. The first total energy refers to a total energy of signal energies of the target to be confirmed in the signal sub-bands, and the second total energy refers to a sum of the first total energy and a total energy of signal energies of the target to be confirmed in at least one leakage sub-band. The at least one leakage sub-band is at least one remaining sub-band of the N sub-bands in addition to the signal sub-bands. In some examples, the second total energy may also be a sum of the first total energy and a total energy of signal energies of the target to be confirmed in leakage sub-bands.

Since an energy of the target to be confirmed may be detected in different sub-bands, and a total signal energy (the first total energy) of a real target point in the signal sub-bands should be close to or even equal to the sum of the first total energy and the signal energies of the real target point in at least one leakage sub-band. Therefore, by using the first confidence, it is possible to effectively determine whether the target to be confirmed is a false target.

In some examples, a ratio of the first total energy to the second total energy may be directly calculated as the first confidence of the target to be confirmed. Taking Table 1 above as an example, in response to the first total energy being max (A0, A1, A2, A3, A4, A5, A6, A7), and the second total energy

$$Pow\_sum = {\sum }_{i = 0}^{7} {S}_{i} , tx\_order \_conf1 = \frac{max ( {A}_{0} , {A}_{1} , {A}_{2} , {A}_{3} , {A}_{4} , {A}_{5} , {A}_{6} , {A}_{7} )}{{Pow}_{sum}} .$$

In operation 402, determining whether the target to be confirmed is a false target based on the first confidence.

In some examples, when the first confidence is a ratio of the first total energy to the second total energy, the determination of whether the target to be confirmed is a real target can be made by determining whether the first confidence is greater than a first threshold. In response to the first confidence being greater than the first threshold, it is determined that the target to be confirmed is a real target; otherwise, the target to be confirmed is not a real target, i.e., a false target. The first threshold is a preset adjustable parameter that can be adjusted based on actual data. For example, the first threshold TH_{tx_order_conf1} may be set to 0.75. It can be understood that the larger the first threshold is set, the more accurate the determination of false target, i.e., the better the detection quality of the target to be confirmed.

When it is determined that the target to be confirmed is not the false target, proceed to operation 403 to acquire the parameters of the target. For example, the target to be confirmed is subjected to range measurement, speed measurement, and angle measurement. When it is determined that the target to be confirmed is the false target, proceed to operation 404 to delete the target to be confirmed.

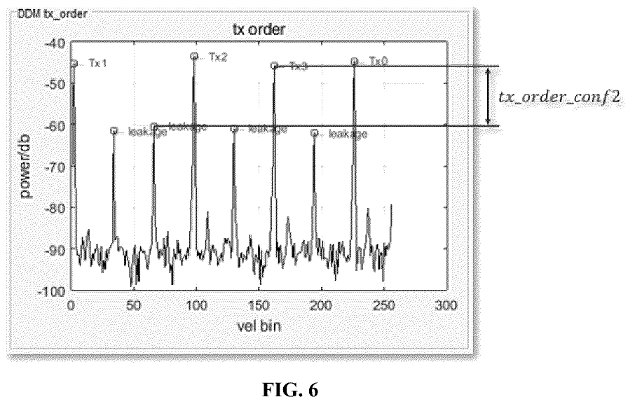

In some examples, a specific process for obtaining parameters of the target based on the signal energies in signal sub-bands is shown in FIG. 5. In operation 501, determining a second confidence (tx_order_conf2) of a target to be confirmed. The second confidence is configured for representing a difference between a first energy value and a second energy value of the target to be confirmed. The first energy value refers to a minimum energy value of the target to be confirmed in the signal sub-bands, and the second energy value refers to a maximum energy value of the target to be confirmed in leakage sub-bands. The leakage sub-bands are remaining sub-bands of the N sub-bands in addition to the signal sub-bands, as shown in FIG. 6.

Since an energy of the target to be confirmed may be detected in different sub-bands, and the energy value of a real target point in a respective signal sub-band of the signal sub-bands should be significantly greater than the energy value of the real target point in a respective leakage sub-band of the leakage sub-bands. Therefore, by using the second confidence, it is possible to effectively determine whether the target to be confirmed is a false target.

In some examples, a logarithm of the ratio of the first energy value to the second energy value may be calculated as the second confidence of the target to be confirmed. The first energy value is defined as min(Ptx0, Ptx1, Ptx2, Ptx3), and the second energy value is defined as max(Plkg0, Plkg1, Plkg2, Plkg3). Ptx0, Ptx1, Ptx2, and Ptx3 are the energy values of the target to be confirmed in the signal sub-band (i.e., the energy values in the sub-bands corresponding to the signals from TX0 to TX3), Plkg0, Plkg1, Plkg2, and Plkg3 are the energy values of the target to be confirmed in the leakage sub-bands, and

$$tx\_order \_conf2 = 10 {log}_{10} ( \frac{min ( {P}_{tx 0} , {P}_{tx 1} , {P}_{tx 2} , {P}_{tx 3} )}{max ( {P}_{lkg 0} , {P}_{lkg 1} , {P}_{lkg 2} , {P}_{lkg 3} )} ) .$$

In some examples, the ratio of the first energy value to the second energy value may also serve directly as the second confidence, which will not be repeated here.

In operation 502, determining whether the target to be confirmed is a false target based on the second confidence.

In some examples, the determination of whether the target to be confirmed is a real target can be made by determining whether the second confidence is greater than a second threshold. In response to the second confidence being greater than the second threshold, it is determined that the target to be confirmed is a real target; otherwise, the target to be confirmed is not a real target, i.e., a false target. The second threshold is a preset adjustable parameter that can be adjusted based on actual data. For example, when the second confidence is set to the logarithm of the ratio of the first energy value to the second energy value, the second threshold may be set to 3. It can be understood that the larger the second threshold is set, the more accurate the determination of false target, i.e., the better the detection quality of the target to be confirmed.

When it is determined that the target to be confirmed is not the false target, proceed to operation 503 to acquire the parameters of the target. For example, the target to be confirmed is subjected to range measurement, speed measurement, and angle measurement. When it is determined that the target to be confirmed is the false target, proceed to operation 504 to delete the target to be confirmed.

In some examples, in operation 105, obtaining the parameters of the target based on the signal energies in the signal sub-bands, can adopt any of the target detection processes shown in FIG. 4 or FIG. 5. That is, for a target to be confirmed, either the first confidence or the second confidence is used to determine whether it is the false target; or both the first confidence and the second confidence are used to determine whether it is the false target. That is, for the target to be confirmed, in response to tx_order_conf2>TH_{tx_order_conf2}, then the target point is retained; otherwise, the target point is deleted.

In some examples, the first confidence may be used first to determine whether a target is a false target. when determined not to be the false target, then the second confidence may be used to determine whether it is the false target. In other words, in response to determining that the target is the false target by using the first confidence, it is not necessary to use the second confidence to determine whether the target is the false target. Only in response to determining that the target is not the false target by using the first confidence, should the second confidence be used to determine whether the target is the false target.

Understandably, when the Doppler spectrum in the preset range bin obtained in operation 102 is data directly output after performing 2D-FFT, when determining the signal sub-bands, the parameters of the target such as range, velocity, and angle can be obtained by adopting any of the target detection processes shown in FIG. 4 or FIG. 5. For example, when using the first confidence and/or the second confidence to determine false targets, subsequent Direction of Arrival (DOA) estimation and resolve velocity ambiguity may be performed based on the signal sub-bands without the need for CFAR.

In some examples, in operation 105, obtaining the parameters of the target based on the signal energies in the signal sub-bands may also omit the determination of false targets based on the first confidence and/or the second confidence. That is, the target to be confirmed may be determined directly based on the signal energies in the signal sub-bands, and subsequent DOA estimation and velocity ambiguity resolution may be performed based on the signal sub-bands.

In some examples, when determining the target to be confirmed based on the signal energies in the signal sub-bands, the target to be confirmed may be deduplicated, and parameters of the target may be obtained from the target to be confirmed subjected to the deduplication. For example, an energy value of the target to be confirmed may be stored in a pre-created two-dimensional matrix. A storage position of the energy value of the target to be confirmed in the two-dimensional matrix is determined based on a range bin value in the range spectrum and a Doppler bin value in the Doppler spectrum. It is determined whether an energy value of a respective target to be confirmed stored in the two-dimensional matrix is greater than an energy value of another target to be confirmed stored adjacent to the respective target to be confirmed. In response to the energy value of the respective target to be confirmed being less than the energy value of the another target to be confirmed, the respective target to be confirmed is deleted as a duplicate target.

Taking the created two-dimensional matrix Pow_matrix of

$$[ \frac{Rng\_nfft}{2} , \frac{Vel\_nfft}{8} ]$$

as an example, Rng_nfft represents a number of range-dimensional FFT points. Rng_nfft/2 is based on the fact that the range-dimensional FFT is symmetric, so only half of the data is meaningful. Vel_nfft represents a number of Doppler-dimensional FFT points. Vel_nfft/8 is an example based on a preset division into 8 sub-bands, where “8” represents a number of preset sub-bands. The algorithm for deduplication of the target to be confirmed is as follows:

First, initializing values of the two-dimensional matrix Pow_matrix to 0. This matrix is used to store energy results of unambiguous Doppler cell peaks.

Then, a Doppler bin ambiguity resolution operation is performed on the target point with determined TX order: the Doppler bin values of the target to be confirmed are taken modulo with respect to

$$\frac{Vel\_nfft}{8} ,$$

and a modulo result is used as a vertical coordinate of the target to be confirmed in the two-dimensional matrix. This operation restricts the Doppler bin of the target point to be

$$0 - ( \frac{Vel\_nfft}{8} - 1 ) ,$$

and the energy of the target point is stored in Pow_matrix.

Finally, energy determination of each target point in the Pow_matrix is made. When the energy of the target point is greater than the energy of four target points above, below, left, and right, the target to be confirmed is output for subsequent range, velocity, and angle measurement. Otherwise, the target to be confirmed is determined to be a duplicate target point and is deleted.

Deduplication may be performed on the targets to be confirmed to remove some target points, thereby preventing output of too much information about duplicate targets.

In the embodiments, the Doppler spectrum includes N sub-bands at equal intervals. The energy of N signals is extracted from the Doppler spectrum, and positional orders of the signals corresponding to the plurality of transmission antennas in the N signals are traversed. Based on a respective total energy of the signals corresponding to the plurality of transmission antennas in each positional order of the positional orders, sub-bands to which the signal corresponding to the transmission antennas belong is determined. Since the position oof the signals of the transmission antennas in the sub-band is determined by traversing all positional orders of the signals of the transmission antennas and using the positional order corresponding to the maximum total energy among the positional orders, the accuracy of channel separation of the transmission antennas is guaranteed, thereby improving the accuracy of target detection. The embodiments can be applied to any non-uniformly spaced DDM-MIMO solutions, and there are no limitations on the number of transmission antennas and receiving antennas. For example, for MIMO solutions, it can be applied to a DDM mode with any number of transmission antennas and receiving antennas, while for other solutions, it is also applicable to solutions with at least one receiving antenna and at least two transmission antennas.

In addition, by using the first confidence and/or the second confidence to determine whether the target to be confirmed is a false target, the false target may be deleted and real targets may be retained, thereby further improving an accuracy of target detection.

In addition, deduplication may be performed on the targets to be confirmed to remove some target points, thereby preventing output of too many targets with repeated information.

Some embodiments of the present disclosure relate to a method for detecting a target. The method is applicable to a radar chip, or to other components, such as terminal devices, and integrated circuits that require acquiring parameters of the target. In some embodiments, the t method includes: performing range-dimensional FFT and Doppler-dimensional FFT on an echo signal to obtain a Doppler spectrum in a preset range bin, and dividing the Doppler spectrum into N sub-bands to determine signal sub-bands to which signals corresponding to transmission antennas belong. The method further includes: determining a target to be confirmed based on signal energies in the signal sub-bands; determining a first confidence of the target to be confirmed. The first confidence is configured for representing a difference between a first total energy of the target to be confirmed and a second total energy of the target to be confirmed. The first total energy refers to a total energy of signal energies of the target to be confirmed in the signal sub-bands, the second total energy refers to a sum of the first total energy and a total energy of signal energies of the target to be confirmed in at least one leakage sub-band, and the at least one leakage sub-band is at least one remaining sub-band of the N sub-bands in addition to the signal sub-bands. The method further includes: determining whether the target to be confirmed is a false target based on the first confidence; and in response to determining that the target to be confirmed is not the false target, obtaining parameters of the target to be confirmed. For ease of understanding, the following embodiments will be mainly illustrated by performing a uniform division on the Doppler spectrum to obtain N sub-bands.

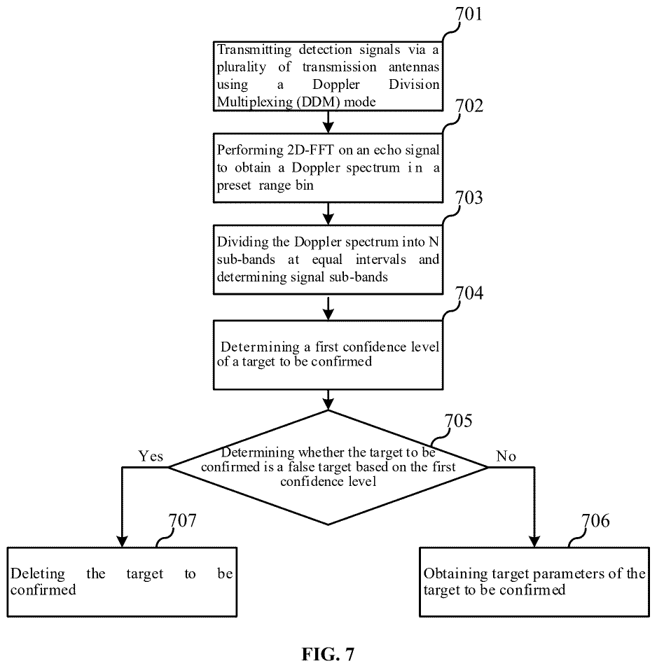

In some embodiments, a specific process of the method is shown in FIG. 7.

In operation 701, transmitting detection signals by a plurality of transmission antennas in a Doppler Division Multiplexing (DDM) mode. The detection signals transmitted by the plurality of transmission antennas are in non-uniformly spaced DDM-MIMO waveform. This operation is similar to operation 101 and will not be repeated here.

In operation 702, performing range-dimensional FFT and Doppler-dimensional FFT (i.e., 2D-FFT) on an echo signal to obtain a Doppler spectrum in a preset range bin. The Doppler spectrum in the preset range bin may be data directly output after performing the 2D-FFT, or data output in response to Constant False Alarm Rate. This operation is similar to operation 102 and will not be repeated here.

In operation 703, dividing the Doppler spectrum into N sub-bands at equal intervals and determining signal sub-bands to which signals corresponding to the plurality of transmission antennas belong. In some examples, the signal sub-bands may be determined through operations 103 to 104 in the above embodiments, which will not be repeated here.

In operation 704, determining a first confidence (tx_order_conf1) of a target to be confirmed. the first confidence is configured for representing a difference between a first total energy of the target to be confirmed and a second total energy of the target to be confirmed. The first total energy refers to a total energy of signal energies of the target to be confirmed in the signal sub-bands, and the second total energy refers to a sum of the first total energy and a total energy of signal energies of the target to be confirmed in at least one leakage sub-band. This operation is similar to operation 401 and will not be repeated here.

In operation 705, determining whether the target to be confirmed is a false target based on the first confidence. In response to determining that the target to be confirmed is not the false target, then proceeding to operation 706 to obtain parameters of the target; in response to determining that the target to be confirmed is the false target, then proceeding to operation 707 to delete the target to be confirmed. Operations 705 to 707 are similar to operations 402 to 404, and will not be repeated here.

In some examples, when determining the target to be confirmed based on the signal energies in the antenna energy sub-bands, a second confidence of the target to be confirmed may be obtained. Based on the second confidence, determining whether the target to be confirmed is a false target, i.e., operations 501 to 502 are executed. In other words, for a target to be confirmed, in response to tx_order_conf1>TH_{tx_order_conf1} and tx_order_conf2>TH_{tx_order_conf2}, then the target point is retained; otherwise, the target point is deleted.

In the embodiments, for a target to be confirmed, by using the first confidence and/or the second confidence to determine whether it is a false target, false targets may be deleted and real targets may be retained, so as to ensure an accurate identification of the real targets and thus improve an accuracy of target detection. In some examples, the first confidence may be used first to determine whether it is the false target, and when it is determined not to be the false target, the second confidence may then be used to determine whether it is a false target.

Some embodiments of the present disclosure relate to a method for detecting a target. The method is applicable to a radar chip, or to other components, such as terminal devices, and integrated circuits that require acquiring parameters of the target. In some embodiments, the method includes: performing range-dimensional FFT and Doppler-dimensional FFT on an echo signal to obtain a Doppler spectrum in a preset range bin, and dividing the Doppler spectrum into N sub-bands to determine signal sub-bands to which signals corresponding to a plurality of transmission antennas belong. The method includes: determining a target to be confirmed based on signal energies in antenna energy sub-bands; determining a second confidence of the target to be confirmed. The second confidence is configured for representing a difference between a first energy value and a second energy value of the target to be confirmed. The first energy value refers to a minimum energy value of the target to be confirmed in the signal sub-bands, and the second energy value refers to a maximum energy value of the target to be confirmed in leakage sub-bands. The leakage sub-bands are remaining sub-bands of the N sub-bands in addition to the signal sub-bands. The method further includes: determining whether the target to be confirmed is a false target based on the second confidence; and in response to determining that the target to be confirmed is not the false target, obtaining parameters of the target to be confirmed. For ease of understanding, the following explanation will primarily use the example of uniformly division of the Doppler spectrum to obtain N sub-bands.

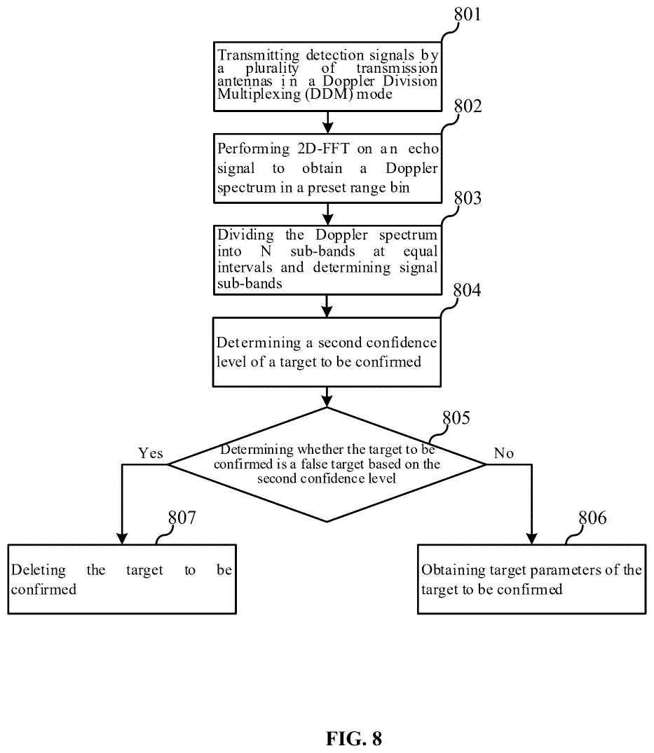

In some embodiments, a specific process of the method is shown in FIG. 8.

In operation 801, transmitting detection signals by a plurality of transmission antennas in a Doppler Division Multiplexing (DDM) mode. The detection signals transmitted by the plurality of transmission antennas are in non-uniformly spaced DDM-MIMO waveform. This operation is similar to operation 101 and will not be repeated here.

In operation 802, performing range-dimensional FFT and Doppler-dimensional FFT (i.e., 2D-FFT) on an echo signal to obtain a Doppler spectrum in a preset range bin. This operation is similar to operation 102 and will not be repeated here.

In operation 803, dividing the Doppler spectrum into N sub-bands at equal intervals and determining antenna energy sub-bands, i.e., signal sub-bands to which signals corresponding to the plurality of transmission antennas belong. In some examples, the signal sub-bands may be determined through operations 103 to 104 in the above embodiments, which will not be repeated here.

In operation 804, determining a second confidence of a target to be confirmed. The second confidence is configured for representing a difference between a first energy value and a second energy value of the target to be confirmed. The first energy value refers to a minimum energy value of the target to be confirmed in the signal sub-bands, and the second energy value refers to a maximum energy value of the target to be confirmed in leakage sub-bands. The leakage sub-bands are remaining sub-bands the N sub-bands in addition to the signal sub-bands. This operation is similar to operation 501 and will not be repeated here.

In operation 805, determining whether the target to be confirmed is a false target based on the second confidence. In response to determining that the target to be confirmed is not the false target, then proceeding to operation 806 to obtain parameters of the target; in response to determining that the target to be confirmed is the false target, then proceeding to operation 807 to delete the target to be confirmed. Operations 805 to 807 are similar to steps 502 to 504, and will not be repeated here.

In the embodiments, by using the second confidence to determine whether the target to be confirmed is a false target, the false target may be deleted and real targets may be retained, so as to ensure an accurate identification of the real targets and thus improve an accuracy of target detection.

Some embodiments of the present disclosure provide a signal processing method applicable to a radar system with non-uniformly spaced DDM. The antenna array of this radar system includes at least one receiving antenna and at least two transmission antennas. For example, it can be applied to antenna arrays with one receiver and multiple transmitters, or radar systems in a DDM-MIMO mode. Specifically, in response to processing the received echo signals using methods such as mixing, analog-to-digital conversion, and sampling, a two-dimensional range-Doppler spectrum is obtained based on spectral analysis such as range-dimensional FFT and velocity-dimensional FFT. The two-dimensional range-Doppler spectrum serves as data to be processed in subsequent operations. The data to be processed may be the two-dimensional range-Doppler spectrum directly output in response to the aforementioned spectral analysis, or it may be the two-dimensional range-Doppler spectrum output in response to CFAR processing based on the spectral analysis results. Furthermore, the two-dimensional range-Doppler spectrum contains multiple target data spectrum.

Any of the target data spectrum mentioned above may include N sub-bands for further confirmation in the Doppler dimension based on factors such as the step phase value of the transmission antenna transmitting the signal. Furthermore, the sub-band division in the Doppler dimension may be uniform or non-uniform, as long as it ensures that target peak values (energy peaks) corresponding to the transmission antennas are distributed in different sub-bands. For example, the Doppler sub-band division may be based on the minimum step phase value when the transmission antennas transmit the signals. That is, in response to the minimum step phase value being 45°, N is 8 (360°/45°=8), the spectrum may be divided into 8 or 16 sub-bands, i.e., any multiple of 8 is acceptable. Assuming the Doppler dimension includes 512 Doppler bins, when the spectrum is uniformly divided into 8 sub-bands, each of the 8 sub-bands will be arranged sequentially in the Doppler dimension, and each of the 8 sub-bands contains 64 Doppler bins; when the spectrum is non-uniformly divided into 8 sub-bands, the number of Doppler bins in each of the 8 sub-bands may be determined based on the phase stepping law of the transmitted signals transmitted by the transmission antennas. For example, a first sub-band may contain 7 Doppler bins, a second sub-band may contain 9 Doppler bins, and the remaining sub-bands may each contain 8 Doppler bins. There can be various combinations, which can be set according to actual needs. The key is to ensure that the target peak values (energy peak) corresponding to the transmission antennas is distributed in different sub-bands to be confirmed when the spectrum is divided. That is, a sub-band to be confirmed may contain only a target peak value corresponding to one transmission antenna, or it may not contain the target peak value corresponding to any transmission antenna. For example, in some examples, since 360° includes twelve 30°-intervals, in response to the minimum step phase of the signals transmitted by the transmission antennas being 30°, a respective signal of the signals is divided into twelve sub-bands in the Doppler spectrum, i.e., N is 12. Of course, the above is merely an example illustrating the minimum step phase and its corresponding Doppler spectrum division under different conditions. In some embodiments, the minimum step phase and its corresponding Doppler spectrum division can be specifically set according to actual needs and differ from the above example; these will not be repeated here.

Based on the aforementioned N sub-bands, it may be determined which sub-bands in the N sub-bands containing the target peak signal according to the phase stepping law of the signals transmitted by the transmission antennas, combined with the energy and dimension of the signal sub-band combination. That is, the sub-bands containing the target peak signal are determined and designated as signal sub-bands, while the remaining sub-bands are designated as leakage sub-bands (also called empty sub-bands). in some embodiments, while determining the signal sub-bands, the order of the target peak values corresponding to the transmission antennas in the target data spectrum within the N sub-bands arranged sequentially in Doppler dimensions may be obtained, i.e., the corresponding order of the transmitted antennas in the target data spectrum may be obtained. In some embodiments, the operations of determining the signal sub-bands and obtaining the corresponding order of transmission antennas in the target data spectrum may be performed independently.

The order of transmission antennas in the target data spectrum confirmed above may be used to remove adjacent duplicate false targets, resolve velocity ambiguity, and/or estimate direction of arrival, so as to achieve purposes such as improving the accuracy of target velocity and angle measurement.

In some embodiments, based on the signal sub-bands and leakage sub-bands determined above, a corresponding preset confidence is set based on the energy dimension to remove some false targets. When the two-dimensional range-Doppler spectrum directly output in response to spectral analysis is used as the data to be processed, the operation of removing false targets using the aforementioned confidence may replace the CFAR operation in traditional signal processing to achieve corresponding false alarm handling. It can also be combined with CFAR to improve the accuracy of target detection.

For example, the aforementioned preset confidence can be obtained based on the energy of the signal sub-bands and the energy of at least some of the leakage sub-bands. For instance, the preset confidence may include a first confidence and a second confidence. The first confidence may be a ratio of a total energy of the signal sub-bands to a total energy of the energy of the N sub-bands, and the second confidence may be a ratio of a minimum peak value of the signal sub-bands to a maximum peak value of the leakage sub-bands. Simultaneously, false targets may be removed independently based on the first confidence and the second confidence, or they can be combined and used to determine false targets under the condition of satisfying preset judgments. The first confidence may also be a ratio of a total energy of the signal sub-bands to a sum of a total energy of the signal sub-bands and a total energy of preset leakage sub-bands.

It should be noted that, in the signal processing method of the embodiments, the specific implementation solutions can be implemented by those skilled in the art using the technical content described in the method embodiments of the present disclosure, without causing conflict. It will not be elaborated here, but its specific implementation technical content should also be included in the technical solution of the signal processing method embodiments of the present disclosure.

The aforementioned signal processing method is applicable to a radar chip, or to other components, such as terminal devices, and integrated circuits that require acquiring parameters of the target. In some embodiments, the signal processing method is applied to a radar system. The radar system's antenna array includes at least one receiving antenna and at least two transmission antennas. The method includes: performing spectral analysis on an echo signal, to obtain a two-dimensional range-Doppler spectrum; dividing a target data spectrum in the two-dimensional range-Doppler spectrum, into N sub-bands in a Doppler dimension based on a minimum step phase of signals transmitted by transmission antennas; based on a phase stepping law of the signals transmitted by the transmission antennas and a total energy of the signal sub-bands, determining the signal sub-bands among the N sub-bands, and/or, determining the order of the signal sub-bands corresponding to the signals transmitted by the transmission antennas. The signal sub-bands include a target peak signal. For ease of understanding, the following explanation mainly uses the uniform division of the Doppler spectrum to obtain N sub-bands as an example.

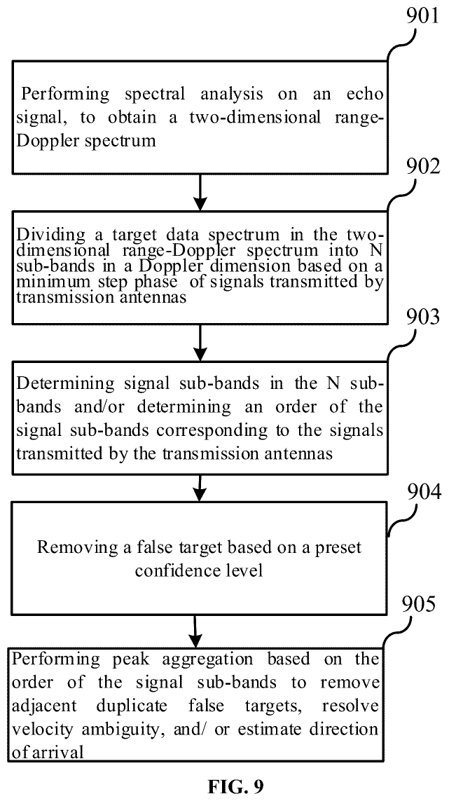

In some embodiments, a specific process of the signal processing method is shown in FIG. 9.

In operation 901, performing spectral analysis on an echo signal, to obtain a two-dimensional range-Doppler spectrum.

In some examples, a detection signal is transmitted by an antenna array of a radar system in a Doppler multiplexing (DDM) mode. The radar system's antenna array includes at least one receiving antenna and at least two transmission antennas. The echo signal is subjected to range-dimensional FFT and Doppler-dimensional FFT (i.e., 2D-FFT) to obtain a two-dimensional range-Doppler spectrum including target data.

In operation 902, dividing a target data spectrum in the two-dimensional range-Doppler spectrum into N sub-bands in a Doppler dimension based on a minimum step phase of signals transmitted by transmission antennas.

In some examples, since 360° includes eight 45°-intervals, in response to the minimum step phase of the signals transmitted by the transmission antennas being 45°, a respective signal of the signal is divided into eight sub-bands in the Doppler spectrum, i.e., N is 8. In some examples, since 360° includes six 60°-intervals, in response to the minimum step phase of the signals transmitted by the transmission antennas being 60°, a respective signal of the signal is divided into six sub-bands in the Doppler spectrum, i.e., N is 6. In some examples, since 360° includes twelve 30°-intervals, in response to the minimum step phase of the signals transmitted by the transmission antennas being 30°, a respective signal of the signal is divided into twelve sub-bands in the Doppler spectrum, i.e., N is 12. Of course, the above are merely illustrative examples of the minimum step phase and its corresponding Doppler spectrum division under different conditions. In some embodiments, the minimum step phase and the corresponding Doppler spectrum division may differ from the examples above, which will not be repeated here.

In operation 903, determining signal sub-bands in the N sub-bands and/or determining an order of the signal sub-bands corresponding to the signals transmitted by the transmission antennas. For example, determining signal sub-bands in the N sub-bands and/or determining an order of the signal sub-bands corresponding to the signals transmitted by the transmission antennas based on a phase stepping law of the signals transmitted by the transmission antennas and a total energy of the signal sub-bands.

Since the embodiments is applied to a radar system with non-uniformly spaced DDM, the phase-shift steps of the transmission antennas are different and also fixed. This means that the relative positions of the signals corresponding to the transmission antennas in the echo signal are fixed. Furthermore, since the energy of the target in the signal sub-bands is greater than the energy in the leakage sub-bands, in this operation, based on the phase stepping law of the signals transmitted by the transmission antennas and the total energy of the signal sub-bands, the signal sub-bands among the N sub-bands may be determined, and/or the order of the signal sub-bands corresponding to the signals transmitted by the transmission antennas may be determined. Here, the signal sub-bands include the target peak signal, and the leakage sub-bands are the remaining sub-bands other than the signal sub-band among the N sub-bands.

In some examples, positional orders of the signals corresponding to the plurality of transmission antennas in the N signals are traversed, a respective total energy of the signals corresponding to the plurality of transmission antennas in each positional order of the positional orders is calculated, and the signals corresponding to the plurality of transmission antennas are determined from the N signals according to a positional order corresponding to a maximum total energy among the positional orders, thereby determining the signal sub-bands. This operation is similar to operation 104 and will not be repeated here.

Through operations 901 to 903, based on a phase stepping law of the signals transmitted by the transmission antennas and a total energy of the signal sub-bands, the signal sub-bands among the N sub-bands are determined, and/or, the order of the signal sub-bands corresponding to the signals transmitted by the transmission antennas is determined. In this way, the accuracy of channel separation for each transmission antenna can be ensured. The obtained signal sub-bands and/or the order of the signal sub-bands corresponding to the signals transmitted by the transmission antennas can be used for subsequent velocity ambiguity resolution and/or direction-of-arrival estimation, thereby ensuring the accurate acquisition of parameter of the target.

In some examples, after operation 903, the signal processing method may include operation 904. In operations 904, removing a false target based on a preset confidence. The preset confidence is determined based on energies of the signal sub-bands and energies of at least some of leakage sub-bands.

In some examples, the preset confidences include a first confidence and/or a second confidence, and false targets are removed based on the first confidence and/or the second confidence. The first confidence is a ratio of a total energy of the signal sub-bands to a total energy of the N sub-bands, and the second confidence is a ratio of a minimum peak value of the signal sub-bands and a maximum peak value of the leakage sub-bands. The specific implementation of removing false targets based on the first confidence and/or the second confidence has been described in detail in the above embodiments and will not be repeated here.

In some examples, after operation 904, the signal processing method may include operation 905. In operation 905, performing peak aggregation based on the order of the signal sub-bands to remove adjacent duplicate false targets, resolve velocity ambiguity, and/or estimate direction of arrival.

In some examples, an energy value of the target to be confirmed may be stored in a pre-created two-dimensional matrix. A storage position of the energy value of the target to be confirmed in the two-dimensional matrix is determined based on a range bin value in the range spectrum and a Doppler bin value in the Doppler spectrum. It is determined whether an energy value of a respective target to be confirmed stored in the two-dimensional matrix is greater than an energy value of another target to be confirmed stored adjacent to the respective target to be confirmed. In response to the energy value of the respective target to be confirmed being less than the energy value of the another target to be confirmed, the respective target to be confirmed is deleted as a duplicate target.

When removing neighboring duplicate false targets, the parameters of the retained targets are obtained, such as more accurate velocity data of the retained targets is obtained through velocity ambiguity resolution, and/or angle data of the retained targets is obtained by estimating direction of arrival.

The operations described above are for clarity only. In practice, they can be combined into one operation or some operations can be broken down into multiple operations. As long as the operations include a same logical relationship, they are all within the scope of protection of the present disclosure. Adding insignificant modifications or introducing insignificant designs to the algorithm or process, but without changing the core design of the algorithm and process, are also within the scope of protection of the present disclosure.

Some embodiment of the present disclosure relates to a non-transitory computer-readable storage medium storing a computer program. Through the description of the above embodiments, those skilled in the art will readily understand that the exemplary embodiments described herein can be implemented by software or by combining software with necessary hardware. The technical solutions according to the some embodiments of the present disclosure can be embodied in the form of a software product, which can be stored in a non-volatile storage medium (such as a CD-ROM, USB flash drive, external hard drive, etc.) or on a network, including several instructions to cause a computing device (such as a personal computer, server, or network device, etc.) to execute the methods described above according to the some embodiments of the present disclosure.

Software products may employ any combination of one or more readable media. A readable medium may be a readable signal medium or a readable storage medium. A readable storage medium may be, for example, but not limited to, an electrical, magnetic, optical, electromagnetic, infrared, or semiconductor system, apparatus, or device, or any combination thereof. More specific examples of readable storage media (a non-exhaustive list) include: electrical connections having one or more wires, portable disks, hard disks, random access memory (RAM), read-only memory (ROM), erasable programmable read-only memory (EPROM, or flash memory), optical fibers, compact disc read-only memory (CD-ROM), optical storage devices, magnetic storage devices, or any suitable combination thereof.

The non-transitory computer-readable storage medium may include data signals propagated in baseband or as part of a carrier wave, carrying readable program code. Such propagated data signals may take various forms, including but not limited to electromagnetic signals, optical signals, or any suitable combination thereof. The non-transitory computer-readable storage medium may also be any readable medium other than a readable storage medium that can send, propagate, or transmit a program for use by or in connection with an instruction execution system, apparatus, or device. The program code contained on the non-transitory computer-readable storage medium may be transmitted using any suitable medium, including but not limited to wireless, wired, optical fiber, RF (Radio Frequency), etc., or any suitable combination thereof.

Program code for performing the operations of the present disclosure can be written in any combination of one or more programming languages, including object-oriented programming languages such as Java and C++, and conventional procedural programming languages such as C or similar languages. The program code can execute entirely on the user's computing device, partially on the user's computing device, as a standalone software package, partially on the user's computing device and partially on a remote computing device, or entirely on a remote computing device or server. In cases involving remote computing devices, the remote computing devices can be connected to the user's computing device via any type of network, including a local area network (LAN) or a wide area network (WAN), or can be connected to an external computing device (e.g., via the Internet using an Internet service provider).

The aforementioned non-transitory computer-readable medium carries one or more programs, which, when executed by a device, cause the non-transitory computer-readable medium to perform the aforementioned functions.

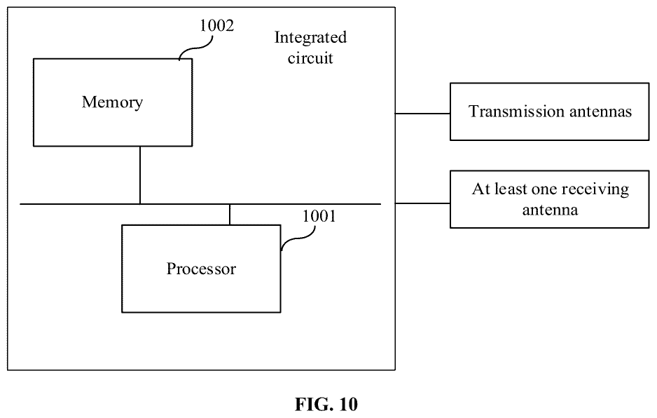

Some embodiments of the present disclosure relate to an integrated circuit, as shown in FIG. 10, including: at least one processor 1001 and a memory 1002. The memory 1002 is configured to store instructions executable by the at least one processor 1001, which, when executed by the at least one processor 1001, cause the at least one processor 1001 to perform the method embodiment described above.

The memory 1002 and the at least one processor 1001 are connected via a bus. This bus can include any number of interconnecting buses and bridges, connecting various circuits of one or more processors 1001 and memory 1002. The bus can also connect various other circuits, such as peripheral devices, voltage regulators, and power management circuits, which are well-known in the art and therefore will not be described further herein. A bus interface provides an interface between the bus and the transceiver. The transceiver can be a single element or multiple elements, such as multiple receivers and transmitters, providing a unit for communicating with various other devices over a transmission medium. Data processed by the at least one processor 1001 is transmitted over a wireless medium via an antenna, which further receives data and transmits it to the at least one processor 1001.

The at least one processor 1001 is responsible for managing the bus and general processing, and can also provide various functions, including timing, peripheral interfaces, voltage regulation, power management, and other control functions. The memory 1002 can be used to store data used by the at least one processor 1001 during operation.

Some embodiments of the present disclosure relate to a wireless device, comprising: a carrier; an integrated circuit, as in the above example, disposed on the carrier; an antenna disposed on the carrier, or the antenna and the integrated circuit are integrated into a single device disposed on the carrier; wherein the integrated circuit is connected to the antenna for transmitting target detection signals and/or receiving echo signals.

When the antenna and integrated circuit are not integrated into a single device, the integrated circuit is connected to the antenna via a first transmission line, which can be a Printed Circuit Board Design (PCB) trace. The carrier can be a PCB, such as a development board, data acquisition board, or the motherboard of a device, etc., which will not be elaborated on here.

Since the structure and working principle of the integrated circuits included in the wireless devices have been described in detail in the above embodiments, they will not be repeated here.

Some embodiments of the present disclosure relate to a terminal device, including: a device body; and a radio device as described above disposed on the device body. The radio device is configured for target detection to provide reference information for operations of the device body.

In some embodiments of the present disclosure, the wireless device may be disposed outside the device body. In some embodiments, the wireless device may be disposed inside the device body. In some embodiments, the wireless device may be partially disposed inside the device body and partially disposed outside the device body, which is not limited in the embodiments of the present disclosure and depends on the circumstances.

It should be noted that wireless devices can achieve functions such as target detection by transmitting and receiving radio signals, providing measurement information of the detected target to the device itself, thereby assisting or even controlling the operation of the device. Examples of measurement information include at least one of relative range, relative speed, and relative angle.

In some embodiments, the aforementioned device body can be a component or product applied in fields such as transportation, consumer electronics, monitoring, in-cabin detection, and healthcare. For example, the device body can be intelligent transportation equipment (such as automobiles, motorcycles, ships, subways, trains, etc.), security equipment (such as cameras), liquid level/flow rate detection equipment, smart wearable devices (such as wristbands, glasses, etc.), smart home devices (such as robot vacuum cleaners, door locks, televisions, air conditioners, smart lights, etc.), various communication devices (such as mobile phones, tablets, etc.), as well as devices such as barriers, intelligent traffic lights, intelligent signs, traffic cameras, and various industrial robotic arms (or robots). It can also be various instruments used to detect vital signs parameters and various devices equipped with such instruments, such as in-cabin detection in automobiles, indoor personnel monitoring, intelligent medical devices, and consumer electronic devices.

In some embodiments, when the aforementioned device is applied to an advanced driving assistance system (ADAS), the wireless device, as an on-board sensor, can provide various functional safety guarantees for the ADAS system, such as automatic emergency braking (AEB), blind spot detection warning (BSD), lane change assist (LCA), and rear cross traffic alert (RCTA).

Furthermore, the examples mentioned in the above embodiments can be freely combined, and any combination can be understood as an embodiment. The terms “embodiment” or “example” appearing in various locations in the specification do not necessarily refer to the same embodiment, nor are they independent or alternative embodiments mutually exclusive with other embodiments. Those skilled in the art will understand that the embodiments described herein can be combined with other embodiments.

Those skilled in the art will understand that the above embodiments are specific embodiments for implementing the present disclosure, and in practical applications, various changes can be made to them in form and detail without departing from the spirit and scope of the present disclosure.

What is claimed is:

1. A method for detecting a target, comprising:
transmitting detection signals using a plurality of transmission antennas;
receiving an echo signal related to one or more of the detection signals;
performing fast Fourier transform (FFT) on the echo signal to obtain a Doppler spectrum in a preset range bin;
extracting energies of N signals from the Doppler spectrum, wherein the Doppler spectrum includes N sub-bands, and each of the N signals belongs to a respective sub-band of the N sub-bands;
transversing positional orders of signals corresponding to the plurality of transmission antennas in the N signals;
calculating a respective total energy of the signals corresponding to the plurality of transmission antennas in each positional order of the positional orders, and determining the signals corresponding to the plurality of transmission antennas from the N signals according to a positional order corresponding to a maximum total energy among the positional orders; and
obtaining parameters of the target based on signal energies in signal sub-bands to which the signals corresponding to the plurality of transmission antennas belong.

2. The method according to claim 1, wherein obtaining the parameters of the target based on the signal energies in the signal sub-bands includes:
determining a target to be confirmed based on the signal energies in the signal sub-bands;
determining a first confidence of the target to be confirmed, wherein the first confidence is configured for representing a difference between a first total energy of the target to be confirmed and a second total energy of the target to be confirmed, the first total energy refers to a total energy of signal energies of the target to be confirmed in the signal sub-bands, the second total energy refers to a sum of the first total energy and a total energy of signal energies of the target to be confirmed in at least one leakage sub-band, and the at least one leakage sub-band refers to at least one remaining sub-band of the N sub-bands in addition to the signal sub-bands;
determining whether the target to be confirmed is a false target based on the first confidence; and
in response to determining that the target to be confirmed is not the false target, obtaining parameters of the target to be confirmed.

3. The method according to claim 2, wherein determining the first confidence of the target to be confirmed includes:
calculating a ratio of the first total energy to the second total energy; and
determining whether the target to be confirmed is the false target based on the first confidence includes:
in response to the first confidence being greater than a preset first threshold, determining that the target to be confirmed is not the false target.

4. The method according to claim 1, wherein obtaining the parameters of the target based on the signal energies in the signal sub-bands includes:
determining a target to be confirmed based on the signal energies in the signal sub-bands;
determining a second confidence of the target to be confirmed, wherein the second confidence is configured for representing a difference between a first energy value and a second energy value of the target to be confirmed, the first energy value refers to a minimum energy value of the target to be confirmed in the signal sub-bands, the second energy value refers to a maximum energy value of the target to be confirmed in leakage sub-bands, and the leakage sub-bands refers to remaining sub-bands of the N sub-bands in addition to the signal sub-bands;
determining whether the target to be confirmed is a false target based on the second confidence; and
in response to determining that the target to be confirmed is not the false target, obtaining parameters of the target to be confirmed.

5. The method according to claim 4, wherein determining the second confidence of the target to be confirmed includes:
calculating a logarithm of a ratio of the first energy value to the second energy value; and
determining whether the target to be confirmed is the false target based on the second confidence includes:
in response to the second confidence being greater than a preset second threshold, determining that the target to be confirmed is not the false target.

6. The method according to claim 1, wherein N is determined based on a minimum phase-shift step of the plurality of transmission antennas relative to a reference transmission antenna.

7. The method according to claim 1, wherein obtaining the parameters of the target based on the signal energies in the signal sub-bands includes:
determining a target to be confirmed based on the signal energies in the signal sub-bands; and
performing deduplication on the target to be confirmed, and obtaining the parameters of the target to be confirmed subjected to the deduplication.

8. The method according to claim 7, wherein performing the deduplication on the target to be confirmed includes:
storing an energy value of the target to be confirmed in a pre-created two-dimensional matrix, wherein a storage position of the energy value of the target to be confirmed in the two-dimensional matrix is determined based on a range-dimension bin value of the target to be confirmed in a range spectrum and a Doppler bin value of the target to be confirmed in the Doppler spectrum; and
determining whether an energy value of a respective target to be confirmed stored in the two-dimensional matrix is greater than an energy value of another target to be confirmed stored adjacent to the respective target to be confirmed, and in response to the energy value of the respective target to be confirmed being less than the energy value of the another target to be confirmed, deleting the respective target to be confirmed as a duplicate target.

9. The method according to claim 8, wherein the two-dimensional matrix is represented as [Rng_nfft/2, Vel_nfft/N], Rng_nfft represents a number of FFT points in a range dimension, and Vel_nfft represents a number of FFT points in a Doppler dimension; and
storing the energy value of the target to be confirmed in the pre-created two-dimensional matrix includes:
performing modulo processing on the Doppler bin value of the target to be confirmed in the Doppler spectrum with respect to Vel_nfft/N to obtain a remainder, and setting the remainder as a vertical coordinate of the target to be confirmed in the two-dimensional matrix; and
determining a horizontal coordinate of the target to be confirmed in the two-dimensional matrix based on a range-dimension bin value of the target to be confirmed in the range spectrum, and storing the energy value of the target to be confirmed in the two-dimensional matrix based on the horizontal coordinate and the vertical coordinate.

10. The method according to claim 2, wherein the Doppler spectrum in the preset range bin is data directly output after performing range-dimensional FFT and Doppler-dimensional FFT; and
obtaining the parameters of the target to be confirmed includes:
performing direction of arrival (DOA) estimation and/or velocity ambiguity resolution on the target based on the signal sub-bands.

11. The method according to claim 1, wherein the Doppler spectrum includes N sub-bands at equal intervals, and every two adjacent signals of the N signals are spaced by a same number of Doppler bins.

12. The method according to claim 1, including:
performing spectral analysis on the echo signal to obtain a two-dimensional range-Doppler spectrum;
dividing a target data spectrum in the two-dimensional range-Doppler spectrum into N sub-bands in a Doppler dimension based on a minimum step phase of the detection signals transmitted by the plurality of transmission antennas; and
determining signal sub-bands of the N sub-bands and/or determining an order of the signal sub-bands corresponding to the detection signals transmitted by the plurality of transmission antennas based on a phase stepping law of the detection signals transmitted by the plurality of transmission antennas and total energies of combinations of the signal sub-bands;
wherein the signal sub-bands refer to sub-bands having target peak signals.

13. The method according to claim 12, further including:
performing peak aggregation processing based on the order of the signal sub-bands to remove adjacent duplicate false targets, resolve velocity ambiguity, and/or estimate DOA.

14. The method according to claim 12, further including:
determining a preset confidence based on energies of the signal sub-bands and energies of at least some of leakage sub-bands, wherein the leakage sub-bands refer to sub-bands of the N sub-bands in addition to the signal sub-bands; and
removing a false target based on the preset confidence.

15. The method according to claim 14, wherein the preset confidence includes a first confidence and/or a second confidence, and removing the false target based on the preset confidence includes:
removing the false target based on the first confidence and/or the second confidence;
wherein the first confidence is a ratio of a total energy of the signal sub-bands to a total energy of the N sub-bands, and the second confidence is a ratio of a minimum peak value of the signal sub-bands to a maximum peak value of the leakage sub-bands.

16. A non-transitory computer-readable storage medium, configured for storing a computer program, which, when executed by a processor, causes the processor to perform operations of the method according to claim 1.

17. An integrated circuit, including:
at least one processor; and,
a memory communicatively connected to the at least one processor;
wherein the memory is configured for storing instructions executable by the at least one processor, which, when executed by the at least one processor, cause the at least one processor to perform the method according to claim 1.

18. A radio device, including:
a carrier;
the integrated circuit according to claim 17 disposed on the carrier; and
antennas disposed on the carrier, or the antennas and the integrated circuit are integrated and disposed on the carrier;
wherein the integrated circuit is connected to the antennas and is configured for transmitting detection signals and/or receiving echo signals.

19. A terminal device, including:
a device body; and,
the radio device according to claim 18 disposed on the device body;
wherein the radio device is configured for target detection to provide reference information for operations of the device body.
